(19) United States
(12) Patent Application Publication
(10) Pub. No.: US 2010/0051739 A1
(43) Pub. Date: Mar. 4, 2010

(54) Method for controlling lifting force of an aerovane fan and a helicar

(76) Inventor: Hongmao Liu, Luoyang (CN)

Correspondence Address: Hongmao Liu, 213, Zhongzhouzhong Road, Xigong District, Luoyang, Henan, 471000, CN

(21) Appl. No.: 12/288,152

(22) Filed: Sep. 24, 2008

(30) Foreign Application Priority Data
May 18, 2006 (CN) 200610082287.2
May 18, 2007 (CN) PCT/CN2007/001628

(51) Int. Cl. B64D 5/00; B64C 39/00

(52) U.S. Cl. 244/2

(57) ABSTRACT

The invention discloses a new method for controlling lifting force of an aerovane fan and a helicar utilizing this method. The method directly controls airflow rate enter a duct (Collar, culvert pipe, in which has the aerovanes fans), using an airflow valve that can be opening or closed by a rotating operation, so to control lifting force. The airflow valve has double layer perforated the hemisphere hulls or hemi-ellipsoid hulls in shape. A simple and practical helicar is designed on the basis of this method. At the center part of the helicar, a duct (Collar) placed upright, in which double aerovane fans rotating in opposite directions with each other; some spouts and grid slices for adjusting airflow are arranged at bottom plate; setting the auxiliary wings that can be foldable and retractable on two sides; a double fins (and rudderpistons); a horizontal empennage (and a elevator); and some tail spouts are provided at the tail part of helicar; an engine is placed at the rear part of the helicar; a cab or passenger chamber are placed at fore of helicar; and furthermore, a series of operate mechanisms is included. The blades of the aerovane fans are fixed at an angle of attack connect with hub fixedly, strong as a whole, the aerovanes fans rotating at a high speed and has small diameter. Therefore, the structure of the helicar is simple and compact. After the wings be retracted and folded, the helicar width may be about 2 meters, which is suitable for driving on the road of ground or flying in the air. When an inflatable rubber gasbag is attached to the bottom plate underside, this helicar also may land on the surface of water and drive on it.

This application is related to a prior patent application filed May 18, 2006 in china (the application number is 200610082287.2); and related the international application PCT/CN 2007/001628 (the international filing date is May 18, 2007, the priority date: May 18, 2006), and had been published on Dec. 6, 2007 by WIPO, the international published number is WO 2007/137501 [The inventor and applicant: LIU Hongmao ( [symbol] ), citizen of China].

### BACKGROUND OF THE INVENTION

This invention involves the vehicle (aerostat, car) technique field, specially involves new technique field that (for domestic use, for public use) vehicle used for traffic (tour) on the land and in the sky (or on the surface of water). Concretely, involves a new method for controlling lifting force of the aerovane fan in a duct (Collar, culvert pipe) and according this way the subassembly, and a practical type the fly car what can vertical lift (a kind of the helicar).

The existing helicopter to be controlling lifting force by the way that changing pitch of blades (or changing screwpiston) of an aerovane, which using a pitch-controlling mechanism. In this (general) way, make the structure of the rotor hub to be complexity, so the total structure strength and credibility degrees of aerovane are not big, isn't suitable for rotating in high speed (so, generally the rev about 200 r/min). But for obtaining a big lifting force, have to use an aerovane with a big diameter (Existing the manned helicopter, the diameter of an aerovane at least need to more than 5 meters). This lead to the general helicopter [and some “fly automobile (car)” which be composed of aerovane of helicopter and the automobile (car) by put together simply] can't drive on the road of ground. The general airplane (even a manned light airplane) can't drives on the road of ground because of its plane wings are lateral outspreading and width is big too. The “fly automobile (car)” what be composed of the airplane with the automobile (car) by put together simply also not practical, because of can't vertical lift and need to continually disassemble and assemble its parts, so is bother. Recent years in the world, some developing of “fly car” by experts, the structure is complicated and cost is expensive, and totally differ from the car structure, difficult to drive on road pass a long distance, difficult to be applied generally, and their credibility and safety are suspicious. Moreover, the method that adopt changing throttle or the rotate speed of the engine to change lifting force of aerovane, are incertitude, due to the aerovane fan respond lag.

### SUMMARY OF CONTENTS OF THE INVENTION

The purpose of this invention is to provide a new method for controlling lifting force of the aerovane fan, and a kind of fly car which utilizing this method and can vertical lift so is practical really (a kind of the helicar) (FIG. 1). Concretely say, the method by the way that adjusting jaw opening of an airflow control valve at air inlet of a duct (Collar, culvert pipe), to directly control airflow (working medium flow) rate passes the duct (Collar, culvert pipe) and inner the aerovane fan, so that to control lifting force of aerovane fan directly, to replace the traditional control method (that by changing angle of attack of blades and the screwpiston of the aerovane) for lifting force of the aerovane, make the aerovane fan can rotate at a high speed, has a smaller diameter, and has fixedpiston, so the structure is hard, in order to bring enough lifting force that can be controlling. Then to design and make the practical fly car with condign size, what can vertical lift and fly maneuver agility, also may to rise or decline and fly be like a general airplane so, also can drives on the road of ground (include the street of city); and then if Add-ons the rubber gasbag attached to underside of soleplate of the helicar, after aerated can also to make the helicar floating and drives on the surface of water; While meeting a danger or urgent circumstance in the sky, can use the compressed air (or to fire a chemical medicament explosion to bring gases) to push open the parachute quickly, so that whole safety to land. The structure of this helicar is simple, the safety is dependable, the cost or builds price is cheap.

The invention discloses a new method for controlling lifting force of an aerovane fan: Adoption the aerovane fan (6) with a fixedpiston and a rating rev in a duct (Collar, culvert pipe) (5); setting an airflow valve (1) for controlling airflow at inlet of the duct (culvert pipe), which is made up of a double layer the hemisphere hulls or hemi-ellipsoid hulls (FIG. 8) and with some louvers may be opening and shutting by turning. By adjusting jaw opening of the louvers on the airflow valve, to control rate of airflow that passes the aerovane fan in the duct (culvert pipe) directly, and simultaneously linkage adjusting the throttle of engine to keep a constant rotate speed. By this way to change, adjust and control lifting force of aerovane fan.

A kind of airflow valve device (1) is setting with the air inlet of a duct (Collar, culvert pipe) (that inner has aerovanes fans), which utilizing above-mentioned the method of this invention presents, it is made of the light metals alloys or composite materials, upper and lower a double layer the hemisphere hulls or hemi-ellipsoid hulls, two-pry may be turned and slippage opposite; some louvers (air holes), the same amount and shape (In particular, the shape as trapezoid on cambered surface such as show of FIG. 7 or FIG. 8) uniformity distributed follows circumference of the hulls. All neighbor barriers and louvers can overlay mutually, due to their shape and width (or area) homologies. When turns opposite two-ply hulls of upper and lower, can change the airflow rate that through the louvers and enter the duct (Collar, culvert pipe) and action on aerovanes fans. And when full admission all louvers, the airflow valve has a maximum total flow area near the cross section of the duct (Collar, culvert pipe).

Setting parachute with a camalig (2) at center of coping of the hulls for if emergency; the circularity edge links the carriage by some bearings at lower part of the hulls, and connect with inlet of the duct (Collar, culvert pipe) by the tubular and flexible compensate joint (adapter) (12). Setting an actuate mechanism the device, for turning two-ply hulls opposite each other.

This invention presents a kind of the helicar what designed adoption above-mentioned method, include above-mentioned device for controlling airflow the airflow valve (1). The foreside of the bodywork is a cab or passenger's chamber, the passenger's chairs position can be adjusted in front and back tiny for trimming; the engine (15) and the compounding gearbox (14) are placed in back; there are two fins (16) each with a rudderpiston (17) at tail of the bodywork; and a horizontal empennage (18) with an elevator (19); Lower the tail of the bodywork, each setting a tee jet pipe (nozzles) [has a main spout (20) and a side direction spout (21)] on right side and left side, and in which setting the valve; By a compounding gearbox (in which setting 8-9 gears combines modes) can expediently to change speed in ground and to switch motion mode of helicar on the land or in the air, in the gearbox setting the power output axis at least two, one stalk connecting with the differential of the back axle of this helicar, another link (the right and left) two segments horizontal axes (which with the cone belt sheave or chain wheel) is locate in front of the compounding gearbox, two horizontal axes parallel and can revolve in direction contrary each other; At the middle part of the bodywork, upright setting a set of subassembly, at least including: a duct (Collar, culvert pipe), a double aerovane fans. Two aerovanes fans setting in the duct (Collar, culvert pipe) and can revolve reverse each other, at its air inlet setting a airflow valve (what said in front of this text), made up of a double layer the hemisphere hulls or hemi-ellipsoid hulls with some louvers, by adjusting airflow intake directly to control lifting force of the aerovanes fans (6) what has the fixedpiston, so to operate the helicar's vertical lift, and a high speed revolve of aerovanes fans is proper to make the attitude stabilization of the helicar to increase in the air, because of the top effect; Setting the parachute with a camalig (2) on the coping of the hulls form valve, for if emergency, and a device for opening the parachute quickly. Between upper and lower the two aerovanes setting a power casing (7) in shape is a cross joint form for transferring and distributing power; the tee form jet pipe (nozzle) connecting with duct (Collar, culvert pipe) (and the aerovanes fans), can bring thrust force and may control motion direction in the sky. The duct (Collar, culvert pipe) may be used to a radiator of the engine concurrently. On two sides of the body of helicar, each setting an auxiliary wing (3) which are extension type, retractable and foldable, after outspread, it can be used for general flying-off, flying or landing, and make the stance stabilization of the helicar increasing; after folding to match, the helicar body become into compact. At lower, the exit of the duct (Collar or culvert pipe, its inner has double aerovane fans) linking with two groups of spouts (31) that located at middle part of soleplate of the carriage and parallel along lengthwise. With the group of the spouts, setting the half cylinder grid form valve, the cascades (4) and the half cylinder glide baffles (33), for adjusting size, direction, and center position of airflow jet that from bottom plate of helicar.

The bodywork total has four wheels where fore and aft. Moreover, setting the auxiliary equipments: the instruments and meter dial for monitoring; the general-purpose steer device for controlling direction on land or in the air; the joysticks for controlling pitching and lifting force of the helicar; the stick shift; a mechanism for controlling the extension type, retractable and foldable the auxiliary wings; The control device used to open and shut or adjust the airflow valve (what made up of hemisphere hulls or hemi-ellipsoid hulls), and for linkage adjusting throttle of engine the device.

Moreover, below the soleplate of helicar, add a rubber gasbag attach to it, link the (bulging/suction) air pump that Add-ons setting with the bodywork, the driver can maintains its a negative pressure to make it cling with the soleplate of the helicar in peacetime, but while need, can gassing by bulging make it becomes a rubber raft, then can make the helicar landing to water surface to drive

### DESCRIPTION BY FIGURES OF DRAWINGS

Underside of this text detailed description to this invention by figures of the drawings.

FIG. 1: The main view (side view, schematic diagram) shows the whole structure of this helicar, which controlling own lifting force by the method that directly control airflow enter and passes two aerovane fans inside a culvert pipe (duct, Collar), therein: (1) is the airflow valve for controlling airflow enter the culvert pipe, made up of a double layer the hemisphere hulls or hemi-ellipsoid hulls; (2) is the parachute with a camalig for if emergency; (3) is one of the auxiliary wings which are extension type, retractable and foldable; (4) is a group of the cascades (grid slices group) which can be linkage to deflect, and with the spouts at soleplate of the bodywork; (5) is the duct (Collar, culvert pipe) (in which setting a double aerovane fans for bringing lifting force); (6) is one of the aerovanes fans; (7) is the power casing used for distributing and delivering power to drive the aerovanes fans; (12) and (13) part each used for upper and lower the compensate joint (the adaptors), they are tubular and flexible; (14) is a compounding gearbox; (15) is the engine; (16) is one of the fins; (17) is one of the rudderpistons; (18) is the horizontal empennage at tail; (19) is the elevator; (20) is one of the main spouts lie tail of the helicar; (21) is a side direction spout lie tail of the helicar and toward a side; (23) is the actuate mechanism for controlling coping the airflow valve; (24) is the steering wheel; (25) is the outside wing panel of the auxiliary wing; (26) is the inside wing panel; (27) is the flap concurrently aileron; (28) is the movable ribs in the cavity of the inside wing panel.

FIG. 2: This planform (diagram) shows the flying appearance of this helicar which have outspread its auxiliary wings and flying in sky, therein: (25) is the extension type and retractable the outside wing panel which has been outspreaded; (26) is the inside wing pane; (27) is the flap concurrently aileron; (28) is the movable ribs in the cavity of the inside wing panel; (29) is an airflow baffle, what setting below the outside end of the inside wing panel, and adown verticality; (30) is an airflow baffle, what setting at below the outside end of the outside wing panel, and adown verticality.

FIG. 3: This planform (diagram) shows one side the auxiliary wing, which has been outspreaded.

FIG. 4: The diagram shows one side auxiliary wing which has contracted, the outside wing panel has been contracted into the cavity of the inside wing panel, some movable ribs which denseness lamination in the cavity of the inside wing panel.

FIG. 5: The schematic drawing shows the section of the auxiliary wing, therein: (26) is the inside wing panel; (25) is the outside wing panel, which has been contracted into the cavity of the inside wing panel; (27) is the flap concurrently the aileron; (29) is the airflow baffle what setting below the outside end of the inside wing panel and adown verticality; (30) is the airflow baffle what setting below the outside end of the outside wing panel, and adown verticality.

FIG. 6: The diagram shows the appearance from head-on the face see this helicar, therein, (3) is an auxiliary wing, which has been shrinked and folded adown so press close to bodywork; (18) is at the tail the horizontal empennage of the helicar.

FIG. 7: The schematic drawing shows an assay what made up of the parts for lifting force that can be control and used for this helicar.

FIG. 8: The schematic drawing shows the airflow valve for controlling airflow of intake at inlet of the duct (Collar, culvert pipe), which made up of a double layer the hemisphere hulls or hemi-ellipsoid hulls with some louvers (the louvers in shape as trapezoid on cambered surface).

FIG. 9: The diagram shows the compensate joint (adaptor) (which in shape as annulus).

FIG. 10: The diagram shows the culvert pipe (duct, Collar) and (across along diameter direction) the tubular power bridge, therein: (8) is the one-way clutch; (9) is the cone belt sheave (or chain wheel); (10) is used to the power bridge the steel (or titanium alloy) pipe; (11) is the drive shaft.

The tubular power bridge (10) and inner the drive shaft (11) all are two segments part at left and right of the power casing (7).

FIG. 11: The diagram shows the heat dissipation tube (radiator) (22) (made of light metal tube has small diameter) in shape of a helix, setting between two layers walls of the culvert pipe.

FIG. 12: The schematic drawing shows the structure of the power casing, which placed at between the two aerovanes fans.

FIG. 13: The schematic drawing shows the structure of an aerovane fan (6).

FIG. 14: The schematic drawing shows the device used for adjusting flow rate and direction of gas jet, which with the spouts groups at soleplate of the bodywork. Therein: (4) is the cascade (grid slices group) what can be deflected; (31) is the spouts group at soleplate of the bodywork; (32) is the grid form valve device what make up of double layers half cylinder, which was perforated with some long form air holes; (33) is the glide baffle in shape of half cylinder surface.

### DETAILED ACTUALIZING WAY

The purpose of this invention can attain by following technique projects:

At the air inlet of the culvert pipe (5) (inside setting double the aerovane fans), [link by tubular and flexible the compensate joint (12)] setting the airflow valve (1) (FIG. 8) what made of the light metals alloys or composite, its structure form is a double layer of hemisphere hulls or hemi-ellipsoid hulls can be turned opposite, and with some louvers (in figure of cambered surface and trapezoid) distribute uniformity at the hulls, by operating the actuate mechanism (23) to turn the hemisphere hulls (or hemi-ellipsoid hulls) opposite, so make them to open or shut or adjusting airiness area of the louver, then adjusting air input directly, (when the louvers opening full, then with the most through flow area look like to equal section of the culvert pipe). And by linkage to adjust the throttle of the engine (to maintain rev at a constant), so to control lifting force bring from the double aerovane (6) (FIG. 13). Setting parachute with a camalig (2) at the center of coping of the hulls, for if emergency, in peacetime, folding the parachute so that to stow. If meet a urgent circumstance in the sky, can quickly (auto or to hand-motion) open the parachute upward by compressed air (or fire the chemicals blast so to bring gases), to prevent from the flying car falling to crash. The aerofoil section of the blades of each aerovane fan similar the blades of aerovane of helicopter, make of the light metals alloy or the composite, and the blades connecting with the hub of aerovane rigidly and firm, and at about ⅔ radius, strengthening with an annulus to link all blades so to add whole strength; The angle of attack of the blades increases gradually from blade tip to root, it is reverse in torsion direction between two sets of blades that upper and lower two aerovanes each bring pitch. Fix overall screwpiston of the aerovanes fans (6) (FIG. 13), so the structure of the aerovanes fans is compact and firmly, can rotating at high speed (may choose rev scope is 1000-4000 r/min). The culvert pipe (5) is make of the light metals alloys and composite, its inner wall make of the light metals which is easy to heat transfer, inside the nip walls of lower part, setting the stainless steel tube (or light metals tube such as aluminium alloy tube or other) (22) which has thin wall and small diameter, be make into a helix, links the water jacket of cylinder of the engine, tandem connecting with a minitype pump for engine heat emission by water cycle, so that the culvert pipe (duct, Collar) used for a radiator of engine concurrently. The weight of lower part of the culvert pipe is more than the upside a bit, so that the culvert pipe (duct, Collar) may be upright natural. Make two ends of the tubular power bridge (10) (that between upper and lower the aerovanes, and level protrude) set into the ears where on two sides middle of the bodywork, and part by the bearing hulls; setting the culvert pipe (Collar, inner has the aerovanes fans) at middle part of the bodywork by a basket form and upright. The angle of the aerovanes fans axis to the lengthwise axis of the bodywork relatively may be changed in the scope of 75°-105°. In tubular arm of right and left the horizontal power bridge, each setting a drive shaft (11) supporting by some bearings; Between upper and lower two aerovanes, and be locate middle of (right and left) two horizontal tubular power bridge, setting the power casing (7) (FIG. 12), and inside power casing setting 4 taper gears joggle each other, of which, two taper gears part fix with the minor axis (two segments face to face upper and lower upright) each via a spline, the upright minor axis supporting by some thrust bearings and centripetal bearings, the other end of two minor axis each fixing fits with the aerovane fans (6) (which upper and lower face to face, and they can rotation and reverse each other); Other two taper gears each fixing with an inner spindle nose of one of two (horizontal and face to face) minor axis; and this two horizontal minor axis are supporting by some thrust bearings and centripetal bearings also. Inside (right and left) tubular power bridge, the spindle nose of drive shaft each links to other nosetip of horizontal minor axis of power casing by the splines. On the outside end of drive shaft (which reach from the outside end of tubular power bridges), setting a combination of the unidirection clutch (8) with the cone belt sheave (or chain wheel) (9) (FIG. 10), part each linking one of two parallel level axes (which drive by the export axes of the compounding gearbox (14)) at tail of the bodywork, and drive link by the cone belt sheave (or the chain wheel), make two drive shafts can rotate and direction opposite each other on two sides of the power casing, then to drive (upper and lower) two aerovanes fans to rotate and reverse each other.

May setup gears combinations with 8-9 shift gear modes in the compounding gearbox (14) [of which, one or two shift gear mode for airborne; one neutral position for stop; 6 shift gear modes for running (contain backing) on land], can expediently to change motion speed in ground or to switch motion modes of helicar in ground or in the sky.

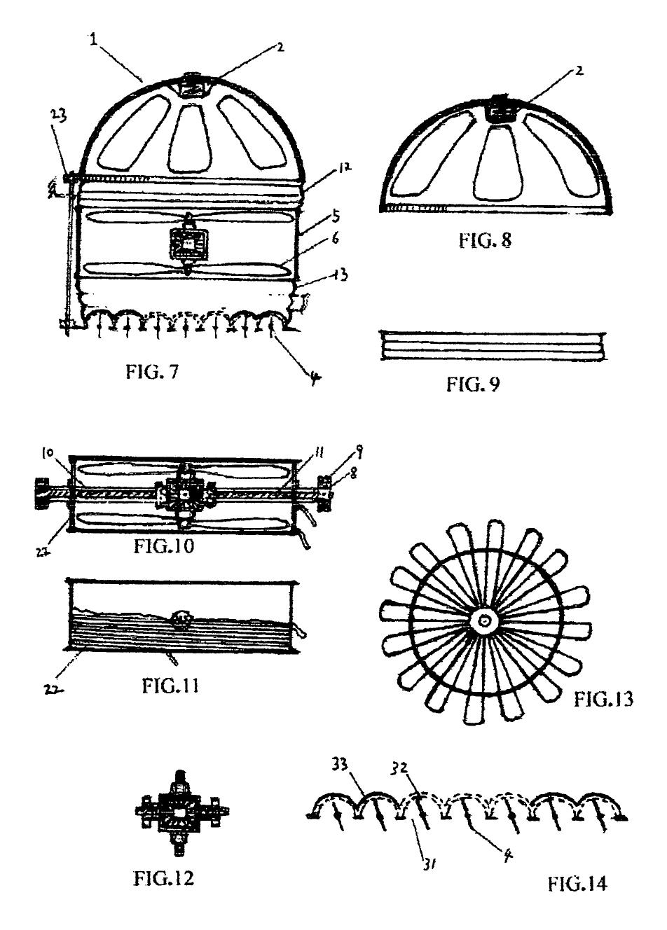

The airflow control valve (what, make of double layer the half spherical hulls or hemi-ellipsoid hulls and with the louvers) (1), upper and lower the flexible compensate joint (adaptor) (12) and (13), the double aerovane fans (can rotating in opposite direction each other) (6), the culvert pipe (Collar) (5) and next the spouts groups (31) at soleplate of the body, and for airflow adjusting the cascades groups (4), etc. They may be composed into an assay (FIG. 7) of the lifting force parts.

At about lower part the flexible compensate joint (13), setting the air exits part link air inlet of the engine and the tail spouts. The engine (15) (such as the internal combustion engine, or the turbine stalk engine, or the rotor engine) placed at tail of bodywork of the helicar. At tail of the bodywork and near two sides each setting a tee form jet pipe (nozzle) (inside with the valve), two are backward the main spouts (20), and, rightward and to left, the side direction spout (21) each one. The tee jet pipe (nozzle) match with the culvert pipe (duct, with aerovanes fans) can used for to bring thrust, and by which the driver can controls direction of this helicar flying in the sky.

Setting double the fin (16) each with a rudderpiston (17), and at the helicar's tail, setting a horizontal empennage (18) with an elevator (19). Setting a cab and the passenger's room at foreside of the bodywork. At middle of foreside, setting the driver's chair, at its two sides (and rear row), may setting the passenger's chairs, which can be adjust in a small range moved onward and back.

In front the driver's seat, setting the gauge board (with the horizon meter; the sideslip meter; the altimeter, the airspeed meter; the plumb accelerometer; the rev meter; the fuel meter; the ground speed meter; the lubricant manometer; the engine thermometer, etc.), the steering wheel (24) (used for controlling the helicar to be changed direction in the ground or in the sky; Under and about the steering wheel, setting the clutch-brake pedal, the stick shift, for the rudderpiston the control footplate (a pair), the (pitching or rise) joysticks (for controlling the flap of the auxiliary wings of two sides, and controlling the tail elevator), the throttle's footplate, an operation handle used for controlling the coping airflow valve (above inlet of the culvert pass pipe), and used for controlling the throttle of the engine at one time by a linkage interlock device, and an operate handle used for controlling the auxiliary wings.

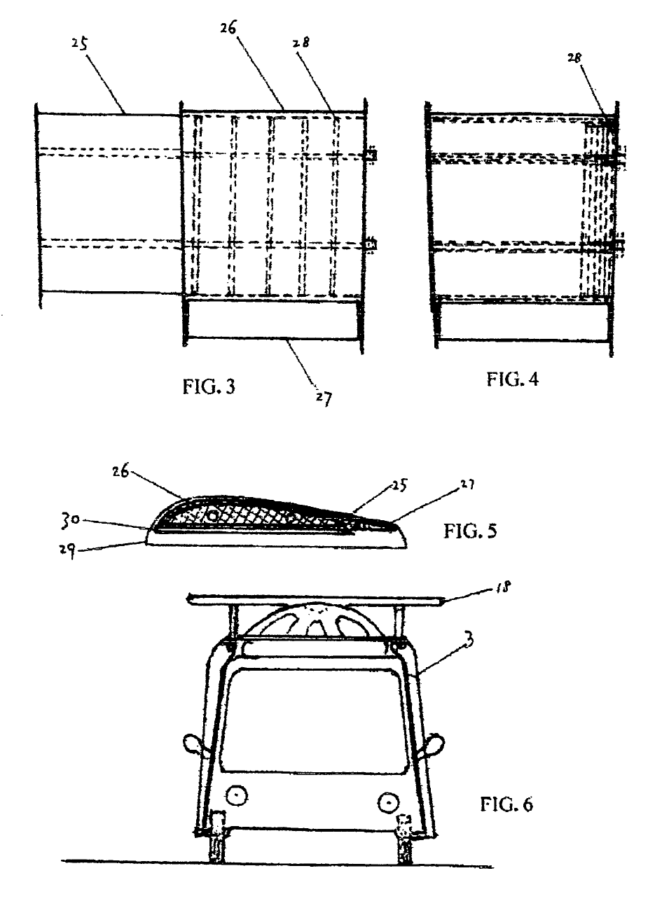

Two sides middle of the bodywork hinging with the auxiliary wings (3) (with a caging device), which make of high strength aluminum metal alloys and composite, they are extension type, retractable and foldable. The auxiliary wings structure by two pieces, of which, include the inside segment (inside wing panel) and the outside segment (outside wing panel) (FIG. 3). The (thin and narrow of) outside segment (outside wing panel) (25) can be retracted into the cavity (thick, breadth of) pre-placed in the inside segment (26) (FIG. 3). The end of inside segment and outside segment each with the airflow baffle (29, 30) which adown reaching 20-30 cm perpendicularly used for to avoid eddying at wingtip. Setting the flap (and also used for aileron concurrently) (27) placed where the inside segment width large than outside. For making the inside wing panel can still bear the barometric pressure after the outside wing panel outspread, strengthen the crust structure of the inside wing panel appropriately, and in pre-place of the cavity, setting some movable ribs (28) with caging device, they can (follows the outside wing panel stretch) dispersion and fixed position to prop aerofoil by along inside spars glide and caging.

After the auxiliary wings outspreaded upward into being even, and after the outside wing panel (25) (it originally hided in cavity of the inside wing panel (26)) put out, total wingspan of this helicar may be extended to 470-800 cm and about, have stability of attitude and bring lifting force by level flying the effect. But, the auxiliary wings can press close to bodywork after they folding adown, to make the helicar body become into compact, total width can about 200 cm, it is suitable for drive on the road of the ground.

At the soleplate middle of the bodywork, appose setting two sets the spouts groups (31), and two group cascades (grid slices group) (4) can be deflected, for adjusting center place and direction of the airflow jet adown. Above the spouts cover the grid form valve (32) what made up of double layer half cylinder the barrier. Two layers the half cylinder of the grid form valve each has 5-7 long blowholes (transom) equally alternation distribution. Two layers the half cylinder barrier glides opposite can to adjust rate of airflow jet. Underneath, the grid slices of the cascade device can linkage to be deflect, one head of the grid slices can be deflected similar the strickles press close to the half cylinder undersurface of the grid form valve, so regulating the direction of airflow jet. Above two sets of the grid form valves, each add in fore and back setting 2-4 half cylinder the glides baffles (33), [Also pre-place 5-7 long blowholes (transom) equally alternation distribution], can respectively glide at upper-surface of the half cylinder grids, by resist airflow of fore or back to adjust center position of flow jet, to regulate pitching balance of fore and rearward of this helicar.

Setting total 4 wheels at fore and rearward of the bodywork by suspension, of which, two be used for guides direction at fore, and other two are drive wheels at rearward. Setting a differential device with the back shaft bridge, it connecting to the compounding gearbox by the cone belt (or chain, gear).

The fuel tanks (may make into four) distributions about the duct (culvert pipe, Collar, inner with the aerovanes fans), and can also make into a tubular entresol and fit round lower part of the culvert pipe.

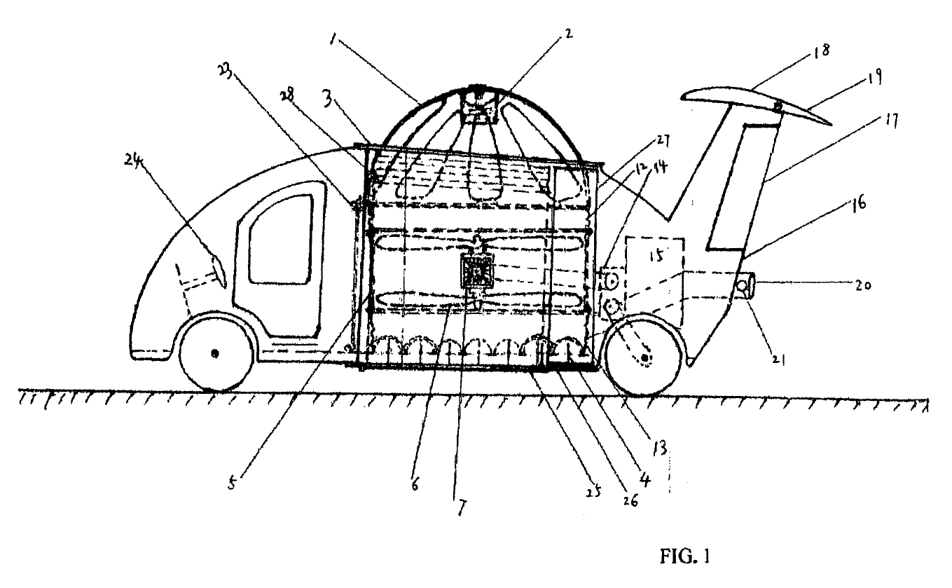

The lengthways section of the body, is similar an aerofoil of a thick wing, and at middle part of the body, top similar in shape of the UFO (FIG. 1) a bit.

Further, add the rubber gasbag attach to underside of soleplate of helicar (except the place of the spouts groups at bottom), and connecting with a bulging/suction pump. The peacetime, can maintain a negative pressure to make the rubber gasbag cling with underside of soleplate of the helicar, but while need, can gas charging, to make the rubber gasbag expanded. When its physical volume attained can make own push out water quantity enough to bring a buoyancy to equal this helicar's weight, the helicar can land to a surface of water, and push by gas jet from tail spouts, so, this helicar can run on the surface of water.

When the helicar is parking in ground, the gear mode of the compounding gearbox is placed in neutral position (zero span), two sides the auxiliary wings appear its retracted and folded downward (caging) form, and cling to body of the helicar (such as FIG. 6).

When drives on road of ground, on two sides, the auxiliary wings of helicar are retracted and folded downward (caging), and cling to the body, the body total width can near 2 meters at this time; The stick shift (the gearbox) is located on certain gear mode in the gears range for driving in ground. The engine drives the tear wheels of the helicar; At middle of soleplate the grid form valve closed, and the grid slices of the cascades (what used for adjust airflow) closed upward; The hemisphere hulls (or hemi-ellipsoid hulls) form the airflow valve be closed (which is locate middle of helicar's coping), only foreside keep an air inlet, in order to provide air toward the engine, in this time the steer device only controls two wheels at fore; The elevator of the horizontal empennage at tail is placed about level and deflected at a certain angle slightly downward, in order to counteract the lifting force which bring by soleplate, when the helicar runs at high speed in ground, so that insure the fore wheels grasps ground, and may keep the direction maneuverability.

When beginning to flying-off vertically from parking state in ground, after launch the engine from the stick shift be placed in neutral position, opening the grid form valve (which with the spouts at soleplate), and make (used for adjusting airflow) the grid slices of cascades into stick up straight adown; Close all tailing spouts; The feet tramples the clutch pedal to push the stick shift forward to end, make the gearbox put up the gear suits flight in order to the helicar can frying-off (here the link gears make the steer device off contact of fore-wheels, turn his steps to control side direction the spouts of tail and control the ailerons of two sides). After the double aerovane fans (in duct or culvert pipe, Collar) rev reach a rating, and lube pressure reach a normal value, operating the (linkage device) control handle, opening the hemisphere hulls (or hemi-ellipsoid hulls) form airflow valve gradually, to increase intake airflow and the throttle of the engine. The lifting force to largen gradually, along with air input increases (passes airflow valve), and adown the airflow jet (from the spouts at soleplate of helicar) increases. When jaw opening of the hemisphere hulls (or hemi-ellipsoid hulls) form air valve reach about ⅔ of the most value, then the lifting force reach slightly bigger than the weight of helicar, to make the helicar beginning go up to sky slowly and vertically.

While the helicar leaving from the ground 2-3 meters, may push the handle slightly to decrease the lifting force so to make the helicar to maintain hovering a while, for checking the equilibrium condition of body of helicar (by observing the horizon or gradienter and other instruments). If fore or aft is lopsidedness, then can adjust center position of airflow jet from spouts at soleplate, using equilibrium control handle (close parts of fore or aft spouts by move the glide baffle), after the body of helicar become into equilibrium, then increase airflow jet continue to rise.

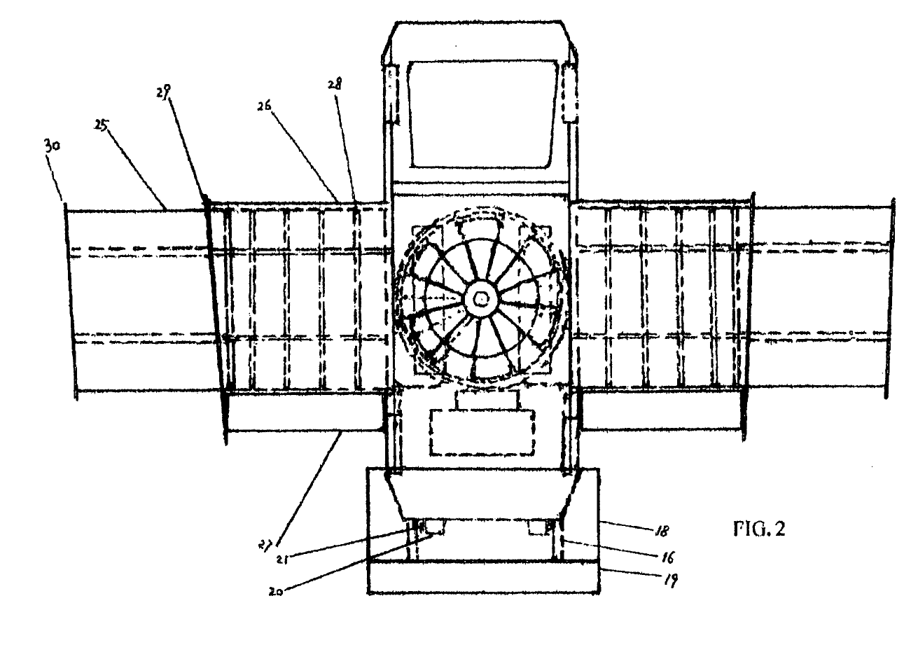

While rising reach some one height, can operating the actuate mechanism to open (extend) two sides the auxiliary wings (FIG. 2), to increase equilibrium of two sides. When the surroundings space is spacious, can also outspread the auxiliary wings first (Or half opening the wings, like open up the inside wing panels only, but don't stretch out the outside wing panels), then to begin go up to sky vertically.

When rise to a certain height and begin hovering, by operating coping the hulls form airflow valve to adjust size of air inflow (and jaw opening of the throttle), make the lifting force size consistent with weight of the helicar. If want hovering a long time, in addition to maintain the equilibrium of fore and aft, may outspread the auxiliary wings to increase side direction balance degree when the surroundings have no obstacles.

When rise to a destine height and preparation to level fly, outspread the auxiliary wings, operating the control handle to increase airflow input, simultaneously make the regulate grid slices of cascades (below bottom spouts) to deflect slowly backward and down, can change direction of the airflow jet (make it to blow off backward and adown), then to exert a thrust force on the helicar body forward and upward directional, the perpendicular upward component (namely lifting force) sustains the weight of helicar, the level direction component pushes on this helicar so to accelerate it forward or maintain a uniform speed motion. In an allow the scope, forward the level component (thrust) increase follow airflow input or jet out, and follow gradient of the (airflow regulate) grid slices of the cascade backward aggrandizement; Contrarily, the level component (thrust) can decrease. Thus, can to operate this helicar to accelerate or maintain level fly at a uniform speed.

The level direction thrust force can also bring by adopting another one method: Maintain the grid slices of the cascades adown, so make the gas jet vertically adown from the spouts at soleplate of helicar, and to increase air input passes hulls form airflow valve at coping of the helicar, simultaneously opening the tail spouts to airflow jet backward, then bring a thrust force forward. When level flying at a low speed, can also outspread the inside wing panel of the auxiliary wings of this helicar.

It is have several cases when turning to dextrad or to left in the sky: 1) When hovering and want to adjust direction of head of the helicar, can open a side direction the spout of tail the tee nozzle (jet pipe) to make it to gas jet, if turning to left can make tail left side direction the spout gas jet to left, contrarily, to clockwise can make tail right side direction the spout gas jet to right (When manipulate, as long as to correspond a direction which is want to and turning the steering wheel). 2) When level flying at a low speed and want adjust direction of head, can make the side direction spout (of the tee nozzle at tail) to gas jet, and assist with manipulate two sides the ailerons (27) and the tail rudderpistons of helicar. 3) When level flying at a high speed and want adjust direction of head, can mainly use a method: by operating the rudderpistons at tail (by treading pedal use feet), and operating two sides the ailerons (Concretely, can make an ailerons deflect upward where the side accord to the turning want to in direction, but another side the ailerons deflect downward).

When to be decelerate (or to back up fly) in the sky, can close tail the spouts, and part the appropriate to increase top enter airflow to increase the lifting force, simultaneously to operate the grid slices of the cascades to be deflect forward and adown, by the action that forward gas jet heft to bring thrust force backwards, so, make this helicar to decelerate in air (at one time, can also make tail the elevator and two sides the flap to deflect adown slowly, to increase drag). When the speed reduced to zero (into hovering), then to operate to make all of the gas jet direction become into adown. If continuing to blow out gas forward and adown a segment of time, can make the helicar fly a distance backward (namely back up).

When this helicar be decelerated and descend to land simultaneously, can close tail the spouts in air, operating the grid slices of the cascades (is locate bottom the spouts) to deflect forward and adown, bring the gas jet heft forward, make this helicar decelerated in air; At one time, decreasing gas jet heft adown, let the lifting force decrease to less than helicar's weight a bit.

When hovering in air and want descend to landing, may decrease jaw opening of the hulls form airflow valve which at the coping of the helicar, let lifting force decreased to less than helicar's weight a hit, can make this helicar to perpendicularity descend air to land. While near (not-spacious) a ground, first retracted and folded the auxiliary wings, then to land the ground.

When parking in ground and want (be like the general aeroplanes) takeoff in general mode, can launch the engine while gearbox in neutral position, close the spouts at soleplate (by closing the grid form valve, and regulating the grid slices of the cascades to make them deflect upwards to close), open the tail spouts, completely outspread two sides the auxiliary wings, the feet trample clutch pedal and the hand push the stick shift to end of front, make the compounding gearbox pin up the gear for flying. While to take off, can completely open the airflow valve at coping of the helicar (linkage enlargement the throttle), make the helicar accelerate a glide. Can also adopt high-speed gear mode in ground, after this helicar accelerated to a certainty speed, then the feet trample clutch pedal, pin up the gear for flying, continue to accelerate, when the speed increase to a certainty value, can to operate two sides the flap of the auxiliary wings, and simultaneously to adjust the tail elevator make the helicar going to sky.

When rise to a certain height, can to operate the tail elevator and two sides flaps of the auxiliary wings, change fly state to general level.

When level flying in general mode, to equilibrium the weight of helicar, the lifting force is make up of follows: 1) By auxiliary wings motion bring the lifting force; 2) By the helicar motioning the soleplate bring the lifting force; 3) The tail horizontal empennage motioning bring the lifting force.

When this helicar flight in general mode and want descent air to land, can operate it to let gas jet decrease from tail the spouts, make the helicar decelerated, then decrease lifting force and gradually lower height. Decline reach a certain height, make two sides the flaps (27) to deflect a biggest angle downward (to a certain the degree increment of lifting force).

When close to the ground, operating tail elevator to deflect upward, to rise a little of helicar's head and make the tail wheels set down ground first, subsequently the fore wheels to ground. After completely to the ground, can using a brake device to make this helicar bring to rest.

After land and want change the motion mode into run in the ground, can make the auxiliary wings retracted and folded, and adjusting the gears of the compounding gearbox to the range accord to drive in the ground.

When running on road of ground and want change mode to fly to rise, like driving on a long superhighway what straight and spacious, and there are no other vehicles or objects where about and in front and back a certain distance of this way, want going up into the sky to fly, the driver can opening tail the spouts, the feet to step clutch pedal and adjusting the shift gear of compounding gearbox for flying, to drive double aerovane fans to rotation at a high speed in the duct (advert pipe); Also to outspread the auxiliary wings, opening the airflow valve at coping, increase airflow input and (linkage) increase the throttle. After the helicar be accelerated to a certain speed, to operate tail the elevator (and two sides the auxiliary wings) can make this helicar to fly to rise.

In order to make this helicar can landing water surface to drive, we may set (a certain capacity and shape of) an inflatable rubber gasbag attach to underside the soleplate of helicar (except the positions of two sets spouts and four wheels), make the rubber gasbag connect with an additional of small bulging/suction air pump. When driving on the land and flying in the air, the driver may maintain a certain negative pressure to make the rubber gasbag cling with soleplate of helicar. While the helicar is demanded to land a surface, can use the air pump to make the rubber gasbag inflate and become into a rubber raft, after the physical volume of the rubber gasbag by inflated make it may push out water quantity enough to prop up weight of this helicar, can slowly land a surface of water. Then close the spouts of soleplate. Drive in the surface can push by the tailing spouts gas jet, at tail two sides spouts can be used for change direction also.

### THE INDUSTRIAL (TRAFFIC) UTILITY

The new principle method presented by this invention for controlling lifting force of the aerovane fan, and can carry out the details structure, and designed on this basis, the helicar (described as above) have some obvious advantages as follows:

1) Used for a key part, the structure of the aerovanes fans is compact and firmly, the diameter may smaller, can rotating at a high speed, run with safety and credibility; And, the aerovanes fans can bring a bigger lift coefficient because it in a pipe (duct, Collar). The airflow valve can easily to control lifting force of the aerovanes fans of helicar, then easily to control the helicar's ascend and descend; The top effect can increase the function of to a steady stance, because of aerovanes fans are rotating at a high speed, and it is locate central part of body of the helicar;

2) After the wings retracted and folded, this helicar body width may be minished to general car's size, then easy to drive on the road; The aviation fly parts organically to combines with the general car parts, make the helicar become into a worthy of the name of practical the fly car.

3) The extension type, retractable and foldable the auxiliary wings and the empennage can make the helicar increases in flight stability, and can also adoption general aero flying off mode and landing mode.

4) At the bottom add an inflatable rubber gasbag can also to make this helicar land to water surface to drive at any time.

5) Setting a parachute at coping of the helicar for if emergency, can to increase the in flight safety.

This invention has disclosed a multifunction vehicle—the helicar which described as above, have the integrated trafficking functions include: the light airplane, the car, the helicopter, even the small boat these vehicle's. This helicar can stay in ground or drive on road, or flying in the sky, even drive or float on water surface; not only can to resolve of ground transportation hustle the problem, but also, has dirigibility and adaptability in all-directions; may be free from the restriction on road situation, it can become a real of (three stay) multilevel traffic vehicle, and can exert manifold utility in the traffic field.

What is claimed is:

1. A kind of helicar which make use of a new method for controlling lifting force of an aerovane fan, its total structure and main characters as following:
The bodywork foreside is cab or passenger's chamber, the position of the passenger's chairs can be adjusted in front and back small range;
An engine (15) and a compounding gearbox (14) are placed in back;
The afterbody has double fin with the rudderpistons, and a horizontal empennage with a elevator; The body fore and aft total has four wheels;
On two sides of the lower part of the afterbody, each having a tee form jet pipe (nozzle) inside with the valve, and the tee form jet pipe has a main spout (20) and a side direction spout (21);
At middle part of the bodywork upright setting a set of subassembly, include: a pipe (duct, Collar), in which has double aerovane fans, upper and lower the aerovanes fans can rotating in directions opposite each other; between two aerovanes setting a (cross joint form) power casing (7) and about it connecting the tubular power bridges (10) (in which setting drive shaft); above inlet, setting an airflow valve (1), what is made up of double layer hemisphere hulls (or hemi-ellipsoid hulls) in shape, make of light metal alloys or composite, with some louvers, and can be turned opposite directions each other, by the way that adjusting airflow input (and output) directly, to control lifting force of aerovanes (has a fixedpiston), then to operate the helicar vertical lifting;
It can bring the thrust force and to control direction in air, by the tee spouts linking with the culvert pipe (duct, Collar, its inner has aerovanes fans); the culvert pipe (duct, Collar) can be concurrently used for a radiator of the engine; at the coping of hulls of airflow valve, setting parachute with a camalig (2) for if emergency, and a device for opening the parachute quickly;
On two sides of the bodywork, each setting a extension type, retractable and foldable the auxiliary wing (3), after outspreaded, the helicar can rise and decline in general mode, and holding its stance in the air; and after folded its wings the bodywork of this helicar is compact;
At lower, the exit of culvert pipe (duct) connecting with two lines spouts groups (31) that distribution abreast and lengthways locate at middle part of soleplate (bottom plate) of the helicar; At middle part of soleplate, two groups of grid form valve and two groups of cascades (each has a set of grid slices) (4) setting with the spouts groups, to adjust rate and direction of the airflow jet; And, above the grid form valve, setting the sliding baffles (33), used for regulating the center place of the airflow jet from bottom plate; the helicar has total tour wheels in fore and afterbody; after add the rubber gasbag to soleplate underside, the helicar may land water surface to float, rest, or runs;
Still have moreover, setting the auxiliary devices, as follows: The instruments and instrument dial that used for monitoring; The general purpose steering wheel (24) used for controlling directions in the sky or on the land; Used for controlling pitching and to change lifting force the joystick, the stick shift; Used for make the auxiliary wings to stretch (or shrink or fold) the operation mechanisms; Used for operating the airflow valve (what in shape is hemisphere hulls or hemi-ellipsoid hulls) the control mechanism, or linkage adjusting the throttle of engine the control mechanism.

2. A kind of helicar according to claim 1, wherein, usage of the new method to control lifting force of the aerovanes fans, its principle characteristics is: Adopting a fixedpiston and a rated rotate speed in used for the aerovanes fans, by the way of adjusting the jaw opening of the airflow valve (1), to control rate of airflow that passes the aerovanes fans in a pipe (duct, Collar) directly; at one time by a linkage to adjust the throttle of engine, and maintaining a constant rotate speed, so to adjust and control the size of lifting force.

3. Adverted to the airflow valve device (1) according to claims 1, 2, setting above the air inlet of a culvert pipe (Collar, inner has aerovanes fans); the valve structure is a double layer the hemisphere hulls (or hemi-ellipsoid hulls), the inside-pry and outside-ply can be turned opposite and glides, made of the light metals alloys or the composite; On two-ply of hulls, there are some the same quantity the louvers (air holes, and specially include a mode what in shape as some trapezia on cambered surface), distributions uniformity along with the circumferential angle, all neighbouring louvers are similar to the separate barriers (in shape, width, or the area size), by turning opposite two-ply of hulls, can change the airflow rate that through louvers to enter the culvert pipe (duct) and action to aerovanes fans; One parachute camalig for if emergency, which placed at center of the hulls coping; the hulls underside links bodywork by some bearings, and by the tubular and flexible compensate adaptor (joint) (12) to connect inlet of the culvert pipe (duct, Collar); A set of the actuate mechanism (23) drives two-ply hulls to turn opposite.

4. Adverted to the subassembly of double aerovane fans according to claim 1, wherein, at least include: A pipe (duct, Collar) (5), and in which has double aerovane fans (with fixedpiston) (6) upper and lower face to face, can rotate reverse each other, the blades aerofoil similar the blades of aerovane of helicopter; a (cross joint form) power casing (7), setting between both and provide power to them; On the left side and the right side of the power casing, respectively links to the tubular power bridges (10) (to bear the weight and transmission drive force), and within them setting the (right, left) drive shafts (11) supporting by the bearings; at the outside nosetip of the drive shafts each setting a unidirection clutch (8), and fit its outside circumference setting the cone belt pulley (or chain wheel) (9); on right side and left side, the tubular power bridges (10) each use one end to connecting with the power casing (in shape similar a cross joint), and other end setting fit with the ear (lifting lug) on two sides of the helicar by sliding bearings, get a structure in shape similar a basket form, it compose of the culvert pipe (duct, Collar, in which setting aerovanes fans) with the helicar's bodywork;
The angle of the bodywork axis to the aerovanes fans axis may changes in a certain scope (75°-105°);
At the lower segment of the culvert pipe (duct, Collar), between the inside and outside walls is the helix tube (22) what close coiled by the stainless steel tube or rest light alloy tube which slender and with thin wall, his two exits are connected to the water jacket of the engine to carry off heat. Between the airflow inlet of the culvert pipe and the airflow valve (made up of hemisphere hulls or hemi-ellipsoid hulls), and between the lower exit of the culvert pipe and the bottom spouts groups (locate at middle part of soleplate of the bodywork), each having the tubular flexible compensate joint (adaptor) (12 or 13) which can be bended; about bottom, the tubular compensate joint (adaptor) (13), have the air exit connecting with the air inlet of the engine and the tail spouts (the exhaust cone) respectively.

5. Adverted to (cross joint form) the power casing (7) according to claim 1, in which setting four taper gears and meshing together each other, wherein, two gears race to race setting at two erect minor axis upper and lower respectively, fits the minor axis setting the thrust bearings and the centripetal bearings, their other end each setting the aerovane fan (6) can rotating at high speed in opposite direction each other; Two taper gears face to face in level is setting to with inner spindle nose of the level minor axis respectively. In tubular power bridges, the inner nosetips of left and right drive shaft, each connecting with an outer nosetips of the drive minor axis of the power casing by the splines.

6. Adverted to the double aerovane fans (6) according to claim 1, the upper aerovane for the lower aerovane, the twist toward of their blades (of) is reverse; all made of the light alloys or composite; From tip to root, the twist angle of the blades of each aerovane fan to augment gradually; the root of the blades combining with the aerovane hub rigidity and fastness, and at ⅔ of radii, a cirque connects all blades and follows the circumference, to increase structure intensity of aerovanes fans as a whole.

7. A kind of helicar according to claim 1, wherein, abreast two lines spouts groups (31) at middle part of soleplate of the bodywork, each has multiple spouts; Above spouts of soleplate, setting the double layers half cylinder the grid form valves group (32), at each ply, some strip form the louvers which equal alternation distributions at the half cylinder surface. Underside, the rectangle grid slices (4) of the cascades group may deflected linkage and encircle axes of each, as the scrapers, upper side of the grid slices can deflected and clung to the undersurface of the half cylinder grid form valve, to adjust the airflow jet direction; fore and aft of each tier spouts group, some glide baffles (33) setting at upper-surface of some the half cylinder the grid form valves, in order to adjust center place of airflow jet, then adjusting pitching balance of fore and back.

8. A kind of helicar according to claim 1, wherein, placed back the compounding gearbox (14), in which setting 8-9 gear shift modes [one or two modes for air, one neutral, 6 modes for driving on road of ground]; its input axis connecting to clutch of the engine: setting the output axis at least two, one of output axis connecting with differential of back axle of helicar, by the chain or cone belt or minor axis, other end of output axis connecting two parallel minor axis by gears in front of the gearbox make two minor axis rotating in directions opposite each other, then drives two motivity half axle rotating in opposite direction is locate at about the power casing, by the cone belt pulley or chain wheel, belt or chain, and the combination from the belt pulley or chain wheel (9) link to the unidirection clutch (8), bring (upper and lower) two aerovane fans rotating in opposite direction with each other, so to work; It is easy to change the motion speed of the helicar in ground, and switch the motion modes where in sky or on road of the ground, by setting and adjusting the gears mechanisms of the compounding gearbox.

9. A kind of helicar according to claim 1, wherein, on two sides of the bodywork the extension type, retractable and folding the auxiliary wings (3) all compose of two segments, the outside wing panel (25) less than the inside wing panel (26) in ply and breadth or span, the root of the inside wing panel articulated with the top of intermediate piece of the helicar's body; At the place where the inside wing panel more man outside wing panel in breadth, setting the briefness flap which concurrently used for the aileron (27), and may be deflected upward or adown; The outside wing panel may shrink into cavity of the inside wing panel, after shrink, the auxiliary wings may be folded adown and cling to the bodywork;
After the auxiliary wings outspreaded upwards to even, inner store the outside wing panel may be put out, then a set of the fulcrum parts (28) (as the movable ribs of inside wing panel, which connecting root of the outside wing panel) also dip shift to scatter to outspread, they supporting (upper and lower) the airfoil surface from the cavity of the inside wing panel; at the wingtips of (inside and outside) wing panel, each setting a baffle (29,30) length 20-30 cm adown vertically to avoid the wingtip eddy. After the auxiliary wings folding adown, the baffles of (inside and outside) wing panels insert the bottom plate underside then to make the bodywork of helicar become into compact.

10. A kind of helicar according to claim 1, wherein, still add a inflatable rubber gasbag attached to underside of bottom plate (soleplate) of the bodywork, connecting with a bulging/aspirator pump what used for an annex of the helicar, at original times can keep a negative pressure get its cling the soleplate of the helicar, but when need, can be in full air, then become into a rubber raft, then the helicar can land on the surface of water and drives.
